(19) United States
(12) Patent Application Publication
(10) Pub. No.: US 2007/0150388 A1
(43) Pub. Date: Jun. 28, 2007

(54) Processing data calls from wireless handsets to information nodes

(76) Inventors: Veena B. Mendiratta, Oak Brook, IL (US); Tushar Shah, Lombard, IL (US); Gustavus H. Zimmerman III, Naperville, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/315,473

(22) Filed: Dec. 22, 2005

(51) Int. Cl. G06Q 40/00

(52) U.S. Cl. 705/35

(57) ABSTRACT

In an exemplary method, a data call origination request containing a URL of the destination web server is received from a wireless handset supported by a mobility service provider at a switching node of the telecommunication network. A determination is made if the owner of the destination web server has agreed to pay for at least a portion of the telecommunication service charge by the mobility service provider for providing wireless access to the wireless handset for the data call. If the owner of the destination web server has agreed to pay for at least a portion of the telecommunication service charge by the mobility service provider, a call detail record associated with the data call is generated that contains information indicating that the owner of the destination web server will be responsible for at least the portion of the telecommunication service charge by the mobility service provider. The data call is then completed allowing packets originated by the wireless handset to be transmitted to the destination web server.

### CROSS-REFERENCE TO RELATED APPLICATION

This application contains subject matter that is related to the subject matter of the following application, which is assigned to the same assignee as this application. The below-listed application is hereby incorporated herein by reference in its entirety: “PROCESSING CALLS FROM WIRELESS HANDSETS TO TOLL-FREE TELEPHONE NUMBERS,” by Veena B. Mendiratta, et al., co-filed herewith.

### BACKGROUND

The present invention is generally directed to wireless data calls and more specifically to how charges for wireless data calls are processed.

Mobility service providers, e.g. a provider of cellular services, offer a variety of plans to subscribers that support the transmission of data. As used herein a “data call” is a communication in which non-voice information is conveyed by data to or from a wireless handset. Some calling plans may offer the subscriber unlimited, or virtually unlimited, inbound amount of data to a wireless handset without incurring a charge per call, per amount of data, or minutes of air time used. Other plans offer subscribers unlimited inbound and outbound data calls to a wireless handset without incurring extra charges if the other party is also a subscriber of the same service provider. Service providers also offer service plans with a low fixed monthly charge, but such plans normally include only a limited number of air time minutes or amount of data usage. Once a subscriber exceeds these limits, the subscriber will incur a charge per minute of wireless access service and/or data usage amount.

Businesses, corporations and information providers typically have a web site to provide data access to information by customers, potential customers or for advertising purposes. This is typically provided as part of a strategy to make doing business or obtaining information easier. A user utilizing a home-based computer with a wire/cable connection to an internet service provider (ISP) does not incur unit charges for access to such web sites. This is because the home user is typically provided an unlimited amount of internet access for a fixed monthly fee.

Although a wireless subscriber can initiate a data call from a wireless handset to a web site, the subscriber is still subject to the terms of the mobility service provider's data/call service plan selected by the subscriber. That is, the subscriber may still be subject to a charge per minute of wireless air time or amount of data usage. Although mobility service providers are linked to the internet, the mobility service providers are separate entities and hence wireless subscribers are subject to the separate billing plan of the mobility service providers. Thus, there exists a need for improved flexibility for handling the billing for data calls originated by a wireless subscriber to web sites.

### SUMMARY

The invention in one implementation encompasses a method. In an exemplary method, a data call origination request containing a URL of the destination web server is received from a wireless handset supported by a mobility service provider at a switching node of the telecommunication network. A determination is made if the owner of the destination web server has agreed to pay for at least a portion of the telecommunication service charge by the mobility service provider for providing wireless access to the wireless handset for the data call. If the owner of the destination web server has agreed to pay for at least a portion of the telecommunication service charge by the mobility service provider, a call detail record associated with the data call is generated that contains information indicating that the owner of the destination web server will be responsible for at least the portion of the telecommunication service charge by the mobility service provider. The data call is then completed allowing packets originated by the wireless handset to be transmitted to the destination web server.

### DESCRIPTION OF THE DRAWINGS

Features of exemplary implementations of the invention will become apparent from the description, the claims, and the accompanying drawings in which:

FIG. 1 is a block diagram of a communication system suited for incorporating an embodiment of the present invention.

FIG. 2 shows an exemplary screen display of a wireless handset in accordance with an embodiment of the present invention.

FIGS. 3A and 3B are flow diagrams of steps in accordance with an exemplary method of the present invention.

### DETAILED DESCRIPTION

As will be explained with regard to an exemplary system diagram, an exemplary method of the present invention provides increased flexibility in determining how data calls are charged that originate from a wireless handset to a web site. In accordance with the exemplary method, a called web site can elect to pay for all or only selected portions of wireless subscriber charges for a data call to the site.

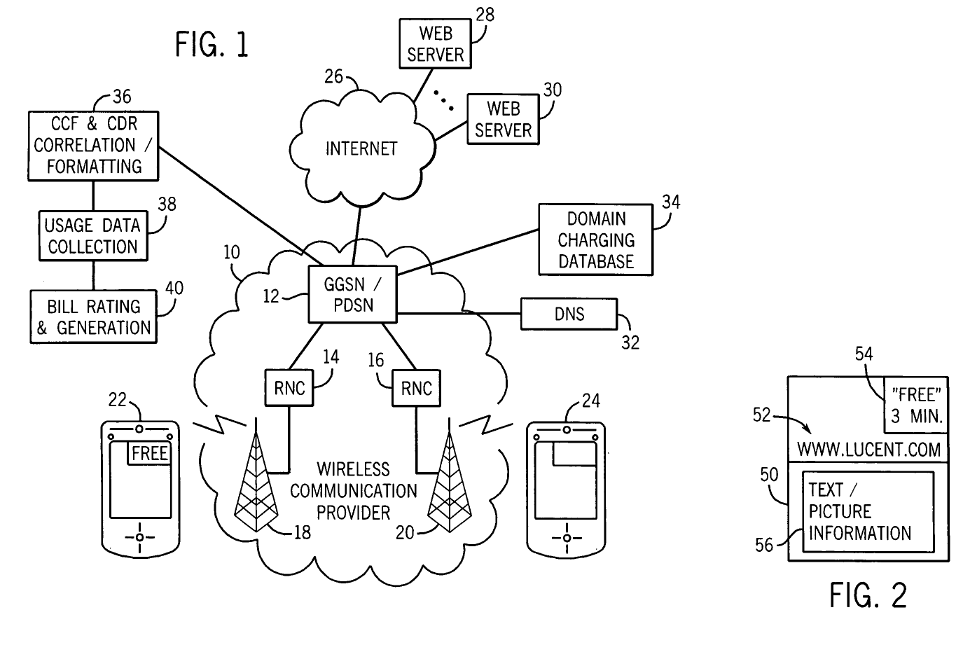

Referring to FIG. 1, a wireless communication provider network 10 includes a traffic handling node 12 which may consist of a gateway GPRS support node (GGSN) or a packet data serving note (PDSN) depending upon the design of the network. The traffic handling node 12 supports radio network controllers (RNC) 14 and 16 that are connected to antennae 18 and 20, respectively. Wireless handsets 22 and 24 have wireless communication links established with the antennae 18 and 20, respectively. The wireless handsets may comprise a traditional cellular telephone with data capability, personal digital assistant (PDA) with wireless communication capabilities, or a portable computing device such as a laptop computer with wireless communication capabilities.

The traffic handling node 12 is coupled to the Internet 26 to which a variety of communication nodes such as web serve or 28 and 30 are also connected. The illustrative web servers are merely representative of a variety of information providing destinations that are available via the Internet. A domain name system (DNS) server 32 is coupled to the traffic handling node 12 and provides the known functionality of translating names of Universal resource locator (URL) locations such as corresponding to web servers/sites into the required corresponding numerical URL address. A domain charging database 34 is also coupled to the traffic handling node 12 and stores records each of which identify a specific URL site. In accordance with the embodiment of the present invention, these records also defined whether the URL site will pay for all or part of the wireless access charges incurred by an originating communication from a wireless handset to the URL site.

The node 12 is also connected to the call charging function (CCF) and call detail record (CDR) correction and formatting workstation 36. It collects the call detailed records normally associated with call originations and terminations, and sorts this data to identify the originating party and called entity for each call session. It is connected to the usage data collection node 42 that compiles the usage information for each subscriber. The usage data collection node 42 is connected to the bill rating and generation node 44 that makes a final calculation of the amount owed for each billing period per subscriber based on the compiled information supplied by node 42.

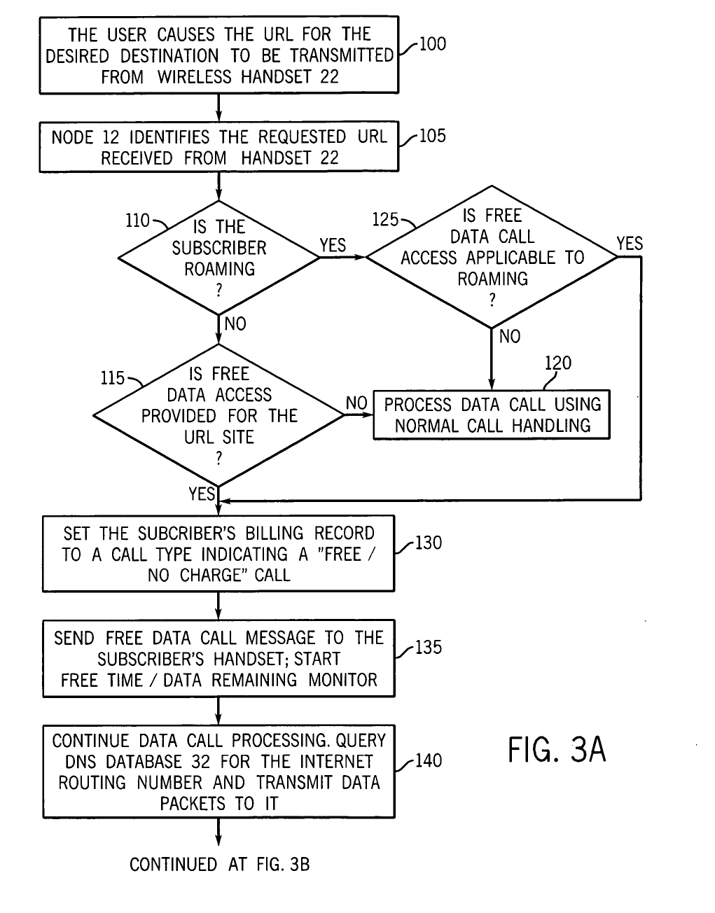

FIG. 2 shows an exemplary screen 50 of a wireless handset display capable of displaying alphanumeric characters as well as other symbols and indicia. As shown, a row 52 of the screen 50 displays the URL of the internet site to which a communication was originated by the wireless subscriber handset. In accordance with a feature of the present invention, an area 54 of screen 50 is utilized to communicate to the subscriber that the data call (or at least a portion of the data call) to the URL site will be “free” to the subscriber. That is, the data call or the indicated portion of the data call will not be billed to the wireless subscriber by the subscriber's mobility service provider. The data call or indicated portion of the data call will be billed to the destination URL site operator. In the illustrative example, the area 54 displays “FREE x data” indicating to the subscriber that the data call will be free to the subscriber for transmission of up to x amount of data. Depending upon the method of charging by the subscriber's mobility service provider, the free portion could be based on amount of air time used. Preferably, the remaining amount of data or free time is periodically updated, e.g. each 30 seconds, so that the subscriber can determine how to manage the data call in view of the remaining free data/time. Periodic messages from the mobility service provider's network infrastructure to the subscriber handset can be utilized to control the information displayed an area 54. Alternatively, in the absence of receipt of such update messages, the subscriber handset itself can be utilized to provide a countdown of remaining free access time/data. Area 56 on the screen 50 contains the text/picture information being transmitted or received. It will be apparent to those skilled in the art that a variety of words, abbreviations, symbols or indicia can be utilized to convey to the subscriber that the data call is being processed as free access to the subscriber.

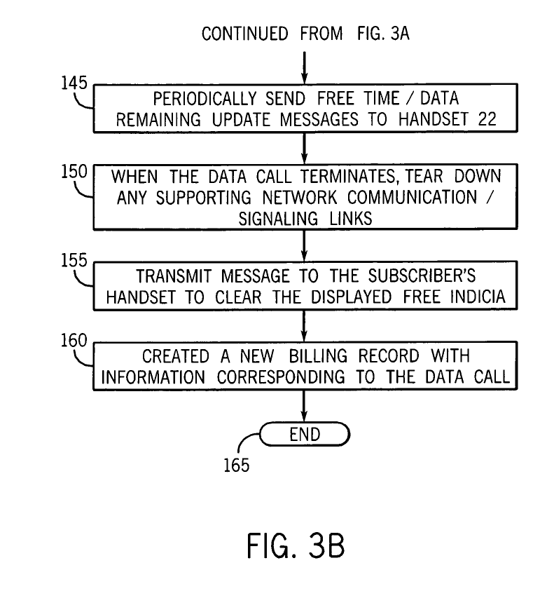

FIGS. 3A and 3B are a flow diagram showing steps in an exemplary method in accordance with the present invention. The flow diagram will be best understood by also referring to FIG. 1. In order to provide free access for wireless subscribers, the owner of the URL destination will have made arrangements with the service provider(s) responsible for maintaining the free domain charging database 34 so that the corresponding URL will reside as a record in this database together with related data call processing information. The data call processing information may include a time/data limit defining a limitation of the amount of time/data for free access, and may further include other restrictions that may select only certain wireless subscribers to receive free access. For example, the URL owner may desire to limit free access to wireless subscribers that: (a) originate wireless data calls from certain cellular networks; (b) originate wireless data calls during a predetermined time interval; (c) have a predetermined origination address; (d) originate wireless data calls within a predetermined geographic area; (e) that are specifically identified in a database based on predetermined demographics such as age, household income, ZIP code, gender, customer lists, employer, etc. As will be known to those skilled in the art, the DNS server 36 will contain a record with the URL and a corresponding routing internet destination number to which packets are addressed for the URL destination.

In step 100 a URL is transmitted from wireless handset 22. In this example the URL consists of the URL, e.g. http://www.lucent.com, of a company that utilizes web server 28 to provide an internet presence. In this example, the Company provides up to three minutes of free data access to wireless subscribers communicating with its web site and has elected to provide this accommodation to all wireless handset users. In step 105 the node 12 identifies the received data call from handset 22 as being directed to a URL by utilizing digit/character analysis. In step 110 a determination is made whether the subscriber is roaming. As will be known to those skilled in the art, such a determination can be made based on information received from a local home location register (HLR), a local visitor location register (VLR), or a local authentication, authorization and accounting (AAA) server depending upon the type of cellular system.

A NO determination by step 110 results in step 115 determining if free access is to be provided based on the URL. The node 12 initiates a query containing the URL to the domain charging database 34. Based on information received in a reply from database 34, node 12 determines if free data access is to be provided. A NO determination by step 115 results in the call being further processed using normal data call handling as indicated in step 120.

A YES determination by step 110 results in step 125 making a determination if free data call access is applicable to the roaming subscriber. The node 12 may transmit a query to the subscriber's home HLR, the local VLR, or the subscriber's home AAA server seeking a determination of whether free data call access is to be applied to the roaming subscriber. Depending upon the telecommunication system design, providing such information will be made the responsibility called one of the appropriate nodes. A NO determination by step 125 results in the call being processed utilizing normal data call handling as indicated in step 120.

A YES determination by step 125 or a YES determination by step 115 results in further processing at step 130. The subscriber's billing record is set to a call type indicating a free/no charge data call. Preferably, this call type is specifically associated with this free access type of service. It will be understood that the generation of a billing record is a normal part of call processing and handling. For example, a CDR is normally generated upon call origination and upon call termination, where the CDR contains the identity of the originating subscriber's handset, the destination URL, call type, event code (origination, termination, etc.) and date/time information. In the illustrative example the CDR corresponding to the call origination would be sent by node 12 to the CCF and CDR correlation/formatting workstation 36.

In step 135 node 12 sends a free data call message to the subscriber's handset 22 and begins to monitor the free time/data remaining. In this example, three minutes of free data access time is provided. The free data call message which includes the amount of free access time provided is received and processed by handset 22 to generate the predetermined free call access information in area 54 of the display screen 50. The free time monitor may consist of a periodically accessed countdown timer such as implemented in software. Alternatively, the amount of free access could be restricted to a predetermined quantity of characters or packets. In step 140, the node 12 continues to process the data call request and initiates a query to the DNS database 32 to seek an internet routing number to which packets are to addressed and transmitted. In this example, database 32 identifies the URL and returns an internet routing number assigned to server 28. The node 12 proceeds to route packets originated by handset 22 via internet 26 to server 28.

In step 145 the node 12 periodically sends update messages to the handset 22 containing information that updates the remaining amount of free access time/data. This information is processed by handset 22 and is utilized to update the displayed amount of remaining free access time/data on its display screen. In step 150 the telecommunication infrastructure equipment initiates procedures upon data call termination. This includes tearing down any supporting communications/signaling links associated with the data call. In step 155 node 12 causes a message to be transmitted to the subscriber handset 22 to clear the displayed free call indicia. This message may consist of a separate message for this specific purpose or may be combined with a call termination message. In step 160 a call termination CDR that will be transmitted by node 12 to node 36 as part of the termination of the call. This concludes the processing as indicated by END step 165.

Periodically the CCF and CDR correlation/formatting workstation 36 processes the received call detail records and assembles the information on a per data call and per subscriber basis. The usage data collection workstation 38 receives this processed information and further correlates the records to determine usage by each calling and/or called (destination URL) party for a predetermined period of time, e.g. typically for each month. The bill rating and generation workstation 40 further processes this information to apply the appropriate charges for telecommunications services to each call originating and call terminating (or URL destination) party.

In the illustrative example, the data call originated from handset 22 will be identified by call type indicating that the charges will be borne by the destination URL party for a predetermined amount time (or amount of data). Any applicable charges for a call duration (or further data) exceeding the predetermined amount of time/data will be billed to the party responsible for charges for the use of handset 22.

A variety of options exist with regard to call management when the predetermined amount of time/data for free data call access expires or is about to expire. In addition to providing the subscriber with a continuing visual update of the amount of time/data remaining in the free data call access period, a visual message can be provided shortly before the free data call time expires advising the subscriber that continuation of the call (or transmission of further packets) will result in normal call service charges being applied for which the subscriber will be responsible. Alternatively, an affirmative action may be required by the subscriber in order to maintain the data call beyond the expiration of the free time/data interval. That is, the subscriber may be required press a key/button on the handset or generate a verbal acceptance that will be transmitted to and processed by the node 12 in order to maintain the call connection/data link. If the node 12 does not receive this indication, an automatic call or data link disconnection can be effected. The subscriber may also be provided with an audible signal such as a beep near the expiration time as an additional alert. Predetermined audible alerts can be provided periodically to correspond with the remaining amount of free time. For example a pattern of beeps can be utilized such as sets of 1, 2 and 3 consecutive beeps that would correspond to one minute, 30 seconds and 15 seconds remaining, respectively.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims. For example, the functionality associated with one node could be distributed to other nodes in the network as well as additional functionality being assumed by a node.

We claim:

1. A method for processing data calls comprising the steps of:
receiving a data call origination request from a wireless handset supported by a mobility service provider at a switching node of the telecommunication network, the data call origination request containing a URL destination of a destination web server;
determining if an owner of the destination web server has agreed to pay for at least a portion of the telecommunication service charge by the mobility service provider for providing wireless access to the wireless handset for the data call;
if the destination web server has agreed to pay for at least a portion of the telecommunication service charge by the mobility service provider, generating a call detail record associated with said data call that contains information indicating that the owner of the destination web server will be responsible for at least the portion of the telecommunication service charge by the mobility service provider;
transmitting packets from the wireless handset to the destination web server.

2. The method of claim 1 further comprising the steps of:
determining if the wireless handset has been granted access to the mobility service provider's wireless network as a roamer;
if the wireless handset is determined to be a roamer, generating a query from a node in the mobility service provider's wireless network to a home network of the wireless subscriber, where the query seeks information to determine whether the destination web server has agreed to pay for at least a portion of the telecommunication service charge assessed by mobility service providers for providing wireless access to the wireless handset associated with a data call to the destination web server;
receiving a reply to the query;
if the destination web server has agreed to pay for at least a portion of the telecommunication service charge by the mobility service provider as determined by information contained within the reply, generating a call detail record associated with the data call that contains information indicating that the owner of the destination web server will be responsible for at least a portion of the telecommunication service charge by the mobility service provider for the roaming wireless handset;
transmitting packets from the wireless handset to the destination web server.

3. The method of claim 1 further comprising the step of transmitting a message to the wireless subscriber handset representing that the owner of the destination web server has agreed to pay for at least a portion of the telecommunication service charge assessed by the mobility service provider.

4. The method of claim 3 wherein the message contains time information indicating a time duration for which the destination web server has agreed to pay for the telecommunication service charge assessed by the mobility service provider.

5. The method of claim 4 further comprising the step of transmitting another message to the wireless subscriber handset representing an update as to the remaining time for which the owner of the destination web server has agreed to pay the telecommunications service charge assessed by the mobility service provider.

6. The method of claim 5 wherein the another message contains a command understood by the wireless subscriber handset to cause an audible alert to be generated by the wireless subscriber handset that is indicative of the remaining time for which the owner of the destination web server has agreed to pay the telecommunication service charge assessed by the mobility service provider.

7. The method of claim 1 further comprising the step of displaying on the screen of the wireless handset indicia indicating that at least a portion of the telecommunications service charge by the mobility service provider will be paid by the owner of the destination web server for the current originated data call from the wireless handset.

8. The method of claim 7 wherein the step of displaying further comprises displaying on the screen of the wireless handset time information indicating a remaining duration of time for which the owner of the destination web server agrees to pay the telecommunication service charge by the mobile the service provider.

9. The method of claim 1 wherein the step of determining if the destination web server has agreed to pay for at least a portion of the telecommunication service charge by the mobility service provider comprises transmitting a query to a database, where the query contains the URL of the destination web server, identifying a record in the data base associated with the URL, and determining from information contained in the record whether the owner of the destination web server agrees to pay for at least a portion of the telecommunication service charge by mobility service providers for a data call made to the destination web server.

10. The method of claim 9 wherein the step of transmitting the query to the database comprises sending the query to the database which is separate from a database utilized to translate URL destinations into internet routing numbers.

11. The method of claim 1 wherein the step of determining if the owner of the destination web server has agreed to pay for at least a portion of the telecommunication service charge by the ability service provider comprises determining if the originating party associated with the originating handset matches a predetermined selection criteria.

12. The method of claim 11 wherein the predetermined selection criteria comprises demographic information associated with the originating party.

13. The method of claim 1 further comprising the steps of:
receiving call detail records associated with the data call, where the call detail records identify the party originating the data call, destination web server and a call type wherein the call type identifies the data call as being at least partially paid for by the destination web server;
processing the call detail records to generate billing statements wherein the owner of the destination web server is billed for the at least portion of the telecommunication service charge by the mobility service provider.

14. A method for processing data calls comprising the steps of:
transmitting to a switching node of a telecommunication network a data call origination request for a destination web server having a URL from a wireless handset supported by a mobility service provider, the data call origination request containing the URL destination of the destination web server;
receiving by the wireless handset a message from the switching node indicating that the owner of the destination web server has agreed to pay for at least a portion of the telecommunication service charge accessed by the mobility service provider for providing wireless communications to the wireless handset for the data call;
displaying, in response to receiving the message, on the screen of the wireless handset indicia indicating that the owner of the destination web server has agreed to pay for at least a portion of the telecommunication service charge accessed by the mobility service provider.

15. The method of claim 14 wherein the displaying step displays the word FREE on the screen.

16. The method of claim 14 wherein the step of displaying comprises the step of displaying, based on information contained in the message, on the screen of the wireless handset an amount of time for which the owner of the destination web server has agreed to pay the telecommunication service charge accessed by the mobility service provider.

17. The method of claim 14 wherein the step of displaying comprises the step of displaying, based on information contained in the message, on the screen of the wireless handset a periodically updated amount of time remaining for which the owner of the destination web server has agreed to pay the telecommunication service charge accessed by the mobility service provider.
